(19) United States
(12) Patent Application Publication
(10) Pub. No.: US 2025/0146308 A1
(43) Pub. Date: May 8, 2025

(54) STATIC ARM PLATFORM

(71) Applicant: Quanta Associates, L.P., Houston, TX (US)

(72) Inventors: Benjamin James HARVEY, Cape Coral, FL (US); Tyler Lee ROSE, Powell, WY (US); Brian Dale BROGAN, Webster, FL (US); Daniel Neil O'CONNELL, Oliver (CA)

(21) Appl. No.: 18/940,383

(22) Filed: Nov. 7, 2024

Related U.S. Application Data
(60) Provisional application No. 63/596,897, filed on Nov. 7, 2023.

(30) Foreign Application Priority Data
Nov. 7, 2023 (CA) 3219003

(51) Int. Cl. E04G 3/24; B64D 1/08

(52) U.S. Cl. CPC E04G 3/243; B64D 1/08

(57) ABSTRACT

A static arm platform for mounting onto a static arm includes a rigid saddle adapted for releasable mounting down onto the static arm, at a desired location along the static arm dictated by a pre-chosen static arm cross section profile formed as lower cut-outs in a pair of gusset plates mounted at each end of the saddle between a pair of rigid flanks extending down the sides of the saddle. The lower cut-outs snuggly fit onto and over the static arm at the desired locations on the static arm to resist a rotation of the saddle relative to the static arm when a lineman is standing on one of a pair of foot decks mounted at the lower ends of the rigid flanks, wherein the rigid flanks define a static arm receiving cavity to envelope the static arm when the static arm platform is mounted on the static arm.

### FIELD

The present disclosure relates to the field of structures for supporting linemen, where the structures are mountable onto the arms which, for example, support static, shield, overhead ground wire or optical ground wires (OPGW) on electrical conductor support towers or structures.

### BACKGROUND

It is conventional to use helicopters to carry a lineman to a location on a high voltage conductor support structure or tower, or to a location along a span of a conductor supported between conductor support towers or structures, so that the lineman may conduct repairs to, or replacement of, components such as insulators, spacers or the like while remaining sitting on, for example, the skid of the helicopter or platform mounted on the helicopter. The helicopter is held in a hover while the lineman does the component repairs or replacement, and once completed, either returns the lineman to the ground or moves on to another aerial location so that the lineman can do the next component repair or replacement. As will be understood, this one-to-one correspondence between the lineman and the helicopter ties up the helicopter, so that other linemen in order to do component repair or replacement in other aerial locations on a tower, structure, or along a span would need other helicopters. The problem with this conventional use of helicopters is that it is an inefficient use of costly helicopter time.

What is needed in order to improve the efficiency in the use of helicopters for such power line work, including energized line work, is an aerial transportable, selectively mountable and selectively removable static platform mountable down onto, for example, the static arm on a tower or structure which supports static wire, shield, overhead ground wire, or OPGW (herein referred to as a static arm) so as to provide a stable working platform on the static arm, in proximity to where the lineman is needed to do the component repair, maintenance, or replacement.

### SUMMARY

One or more embodiments described herein relate to an aerial transportable static arm platform that can be selectively and removably mounted onto a static arm on a support or structure to provide a stable working platform on the static arm for a lineman in proximity to a component needing repair, maintenance or replacement. As described herein, in some embodiments, the lineman and static arm platform are transported by a helicopter to the static arm on a support or structure, and once the static arm platform and lineman are in place, such as seen depicted in FIG. 1, the lineman may be left to work, without the need for the helicopter, until the job is done. The helicopter is thus freed up to return and pick up a second lineman and a second static arm platform so that the second lineman and second static arm platform may be transported by the helicopter to, and left at, a second work location on a second static arm. Within reasonable limits, the single helicopter can then continue to transport, locate, and leave in place further linemen on their installed static arm platforms on separate static arms, and then retrieve and move them one by one when their work is finished. This is a much-improved efficiency in the use of helicopter time as compared to the use of helicopter time in the prior art methods.

The removable static arm platform, to give one example, and not intended to be limiting, may include a rigid saddle sized to fit conformally and snugly over a static arm. The saddle supports cantilevered standing platforms or foot decks on either side of, so as to extend from beneath the saddle to provide a stable platform for a lineman standing on the foot decks. The structure of the static arm platform resists rotation of the saddle relative to the static arm when a lineman is standing on a foot deck on either side of the saddle or straddling the saddle to stand on both foot decks.

The saddle defines a static arm receiving cavity between two generally parallel, laterally spaced apart rigid flank frames, herein alternatively referred to as first and second flanks. The first and second flanks may, for example, be held rigidly spaced apart by at least a pair of gussets, herein alternatively referred to as first and second gussets, which extend between, for example, orthogonally between, when mounted to, the first and second flanks so as to cross the static arm receiving cavity. The first and second gussets each have lower cut-outs therein shaped to conformally and snugly receive a corresponding cross section profile of the static arm. The cross section profiles are located where the static arm platform may advantageously be releasably mounted onto the static arm. Standing platforms or foot decks, for example, resembling cantilevered shelving, and sized so that a lineman may comfortably stand thereon, are mounted to the first and second flanks so as to extend in opposed relation oppositely from, and generally orthogonally to, exterior sides of the first and second flanks.

In alternative embodiments, the first and second gussets may be gusset plates, or other structural members having the aforesaid cut-outs or shaped to perform the function of the cut-outs (hereinafter collectively referred to as cut-outs). The use of cut-outs is particularly useful where the static arm is tapered, whether or not the cross section of the static arm is a circle or a polygon. In other embodiments, cut-outs are not used; instead the rigid flanks themselves are shaped to provide, or merely spaced apart a distance which provides, a relatively tight clearance tolerance on either side of the static arm, so that it is the rigid flanks themselves which provide an anti-rotation gripping or fitting along the sides of the static arm, which may be particularly useful where the static arm has a polygonal; e.g. hexagon or square cross section.

In embodiments employing gussets, including gusset plates, having cut-outs to conformally seat onto the static arm, where the first and second flanks themselves each comprise rigid frames, e.g., planar frames, the gussets are mounted on vertical, or at least upwardly inclined, members (collectively referred to herein as vertical members) of the rigid frames. Advantageously, the vertical members of the rigid frames are configured to; that is, to provide for adjusting the elevation of the gussets in relation to the first and second flanks so as to, for example, account for an upward angular orientation of the static arm when viewed side-on. Advantageously, the gussets may be pinned or bolted or otherwise releasably mounted to the vertical members, for example, along vertically spaced arrays of bolt holes or the like extending along at least part of the length of the vertical members thereby allowing the elevation of the gussets to be selectively adjusted to account for the angular orientation of the static arm prior to mounting the static arm platform onto the static arm.

Further advantageously, the gussets may, when assembling the static arm platform, be chosen from sets of gussets, wherein each gusset within the set has a different profile or lower cut-out so that the static arm platform may be pre-assembled, prior to being transported by helicopter to the static arm, to account for different cross sections on a particular static arm, or a differently shaped static arm; e.g. cylindrical.

For example, and as better described below, conventionally a static arm may be shaped as a polygonal in cross section, for example, forming a six sided (hexagon) or a twelve sided (dodecagon) such as described and illustrated herein. The corresponding gusset plates have a matching partially polygon-shaped lower cut-out so that the gusset plate, when the static arm platform is mounted on the static arm, conformally and snugly lowers down onto, so as to releasably mount down onto the static arm at the desired location along the static arm. The gusset plates may, without intending to be limiting, be planar gusset plates releasably mounted by bolting onto the vertical members. The gusset plates are generally vertical when bolted to the vertical members, so as to be vertical, or at least aligned with the vertical members, when mounted down onto the static arm.

The static arm platform may thus be characterized in one aspect as including a rigid saddle configured to or adapted for releasable mounting down onto a static arm, at a desired location along the static arm. Where the static arm is tapered, whether or not a circle or polygon in cross section, the mounting location of the static arm platform along the static arm is dictated by pre-chosen static arm cross section profiles formed as the lower cut-outs in at least a pair of gusset plates. The gusset plates are mounted so as to cross between the pair of rigid flanks extending down the sides of the saddle. The rigid flanks define a static arm receiving cavity or tunnel so as to flank the static arm when the static arm platform is mounted on the static arm.

The rigid flanks extend downwardly from the saddle. In the illustrated embodiments, not intended to be limiting, the flanks extend both upwardly and downwardly, from opposite sides of, the static arm when the saddle is mounted over the static arm. The rigid flanks may be parallel, or in alternative embodiments (not shown) inclined towards one another, and laterally spaced apart a sufficient lateral distance so that the static arm receiving cavity or tunnel formed between the rigid flanks easily and smoothly fits over the static arm as the static arm platform is lowered, for example, advantageously by helicopter, into place on the static arm. Further advantageously, the static arm platform, when being lowered, is guided by a lineman who is also lowered simultaneously by the helicopter as a combination underslung load.

The lineman engages the static arm as the lineman is being lowered so as to stop any spinning of the static arm platform that may have occurred while the static arm platform and the lineman have been suspended under the helicopter by a long line. Once the lineman stops any spinning, the lineman guides the static arm platform over the static arm so that the flanks of the static arm platform are parallel to the static arm. The static arm platform is then lowered down onto the static arm. As the lower ends of the rigid flanks slide down past the sides of the static arm, the gusset plates, and in particular, the lower cut-outs in the gusset plates, engage the static arm, and snugly seat down onto the static arm where the corresponding cross sectional profiles of the static arm dimensionally match the dimensions and shape of the cut-outs. In one embodiment, the inner sides of the flanks or vertical members are lined with a friction reducing layer, for example, a polymer layer such as ultra-high molecular weight (UHMW) polyethylene.

In alternative embodiments, not shown, outward flaring striker plates may extend downwardly from the lower ends of the rigid flanks so as to flare outwardly of the static arm receiving tunnel so as to assist the centering of the static arm as it enters into the tunnel, especially if the static arm platform is being installed without the benefit of a lineman present to guide the static arm platform down onto the static arm.

Upper ends of the rigid flanks may support a further anchor, herein referred to as an end mount, for anchoring the static arm platform onto the upper or distal end of the static arm. For example, the end mount may be mounted on the end of a coupling arm extending from the saddle or the upper ends of the rigid flanks. When the static arm platform is mounted onto the static arm, the coupling arm extends to the upper or distal end of the static arm. The end of the coupling arm is adapted to releasably couple to the upper or distal end of the static arm, thereby providing another anchoring location of the static arm platform onto the static arm. As illustrated, this may be useful where the static arm has a vertical plate mounted onto its distal end, in which case, an end mount on the end of the coupling arm slides down onto the vertical plate on the end of the static arm. A striker plate extending below the end mount is advantageously used to assist in capturing the vertical plate into the end mount. Alternatively, where the static arm has a horizontal plate on its upper end, the end-mount on the coupling arm may have downwardly extending teeth or pins which engage with holes in the horizontal plate on the end of the static arm.

In the embodiments described and illustrated herein, and as stated above, the rigid flanks may be planar frames and may in particular be rigid rectangular planar frames having vertical members or legs, and horizontal upper and lower members outlining the circumference of each of the rectangular frames. In the illustrated embodiment, the horizontal upper members extend outwardly from the rectangular frames in the vertical plane containing the static arm so as to form the coupling arm which extends from the frames to intersect the upper or distal end of the static arm. The horizontal upper members of the rectangular frames may be offset laterally inwardly out of the plane of their rectangular frame, such as illustrated herein, towards one another so as to be closely adjacent to one another.

In one embodiment, mounting or lifting eyes are mounted to or between the upper members. Lifting hard points may be provided, where the under-slung long line under the helicopter may be releasably attached to the static arm platform. In one embodiment, the lower members of each frame are formed as backing plates, bracing horizontal plates forming each of an oppositely disposed pair of cantilevered foot decks. The lineman stands on the foot deck on one side or the other of the saddle.

Because of the stability of the static arm platform when mounted down onto the static arm using the above summarized structures, and as better described below by way of example, a lineman may stand on the foot deck on one side or the other of the saddle without causing the saddle to rotate about the longitudinal axis of the static arm, and without causing the saddle to pitch; that is, rotate about a lateral axis perpendicular to the longitudinal axis of the static arm, where the longitudinal axis of the static arm is a centroidal axis running along its length. This allows the lineman to stand on one side or the other of the static arm platform without the platform shifting.

It is to be understood that other aspects of the present disclosure will become readily apparent to those skilled in the art from the following detailed description, wherein various embodiments of the disclosure are shown and described by way of illustration. As will be realized, the disclosure is capable of other and different embodiments and its several details are capable of modification in various other respects, all without departing from the spirit and scope of the present disclosure. Accordingly, the drawings and detailed description are to be regarded as illustrative in nature and not as restrictive.

### BRIEF DESCRIPTION OF THE DRAWINGS

A further, detailed, description of the disclosure, briefly described above, will follow by reference to the following drawings of specific embodiments of the disclosure. The drawings depict only typical embodiments of the disclosure and are therefore not to be considered limiting of its scope. In the drawings:

FIG. 1 is a view from below showing a static arm platform according to the present disclosure suspended on a long line from a helicopter while the platform is being mounted on a static arm on a monopole tower;

FIG. 2 is a front perspective view of a first embodiment of a static arm platform according to the present disclosure mounted on a hexagonal cross section static arm;

FIG. 3 is, in plan view, the static arm platform of FIG. 2;

FIG. 4 is, in side elevation view, the static arm platform of FIG. 2;

FIG. 5 is, in front elevation view, the static arm platform of FIG. 2;

FIG. 6 is the view along section line A-A in FIG. 4;

FIG. 7 is the view along section line B-B in FIG. 4;

FIG. 8 is the view along section line C-C in FIG. 3;

FIG. 9 is the view along section line D-D in FIG. 4;

FIG. 10 is the view along section line E-E in FIG. 4;

FIG. 11 is the view along section line F-F in FIG. 4;

FIG. 12 is a front perspective view of a second embodiment of a static arm platform according to the present disclosure mounted on a twelve-sided polygon cross section static arm with a horizontal end plate;

FIG. 13 is, in plan view, the static arm platform of FIG. 12;

FIG. 14 is, in side elevation view, the static arm platform of FIG. 12;

FIG. 15 is, in front elevation view, the static arm platform of FIG. 12;

FIG. 16 is the view along section line A-A in FIG. 14;

FIG. 17 is the view along section line B-B in FIG. 14;

FIG. 18 is the view along section line C-C in FIG. 13;

FIG. 19 is the view along section line D-D in FIG. 14;

FIG. 20 is the view along section line E-E in FIG. 14;

FIG. 21 is, in perspective view, a third embodiment of a static arm platform showing a spreader bar for lifting the static or OPGW wire; and

FIG. 22 is a front perspective view of the static arm platform of FIG. 12.

The drawings are not necessarily to scale and in some instances, proportions may have been exaggerated in order to depict certain features more clearly.

### DETAILED DESCRIPTION

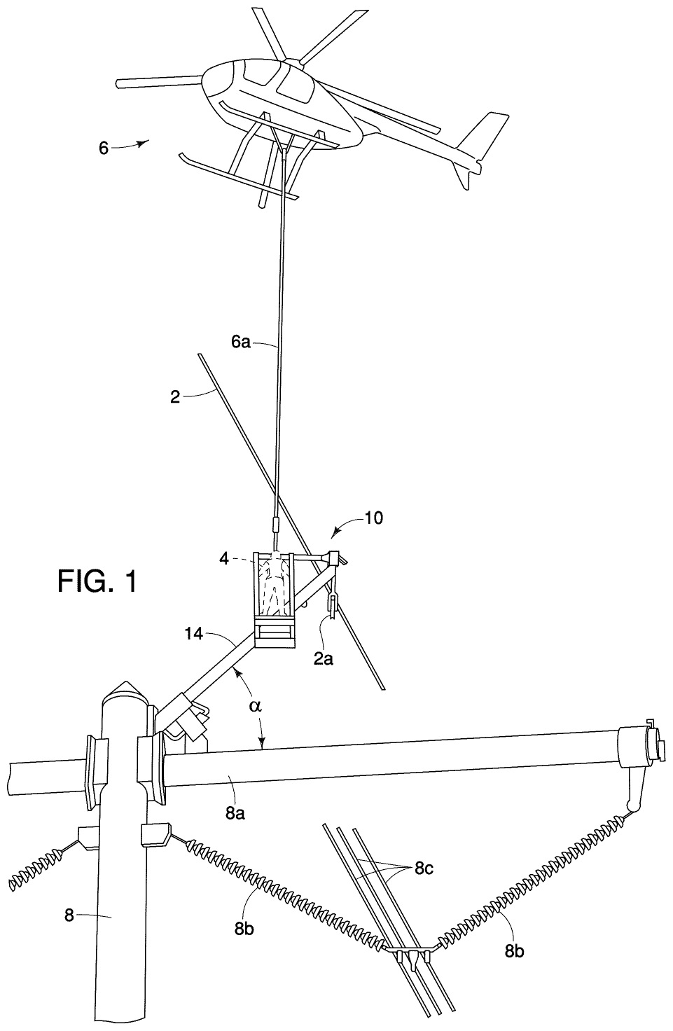

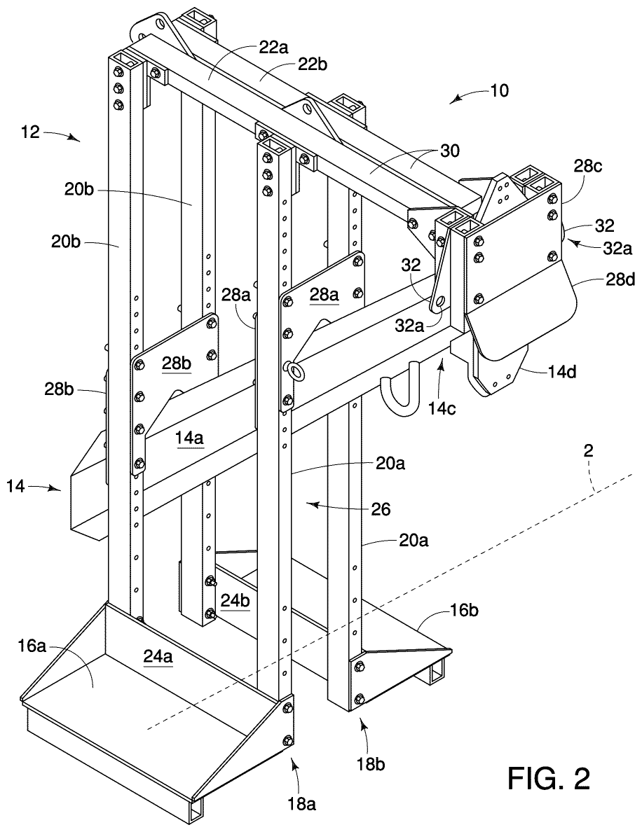

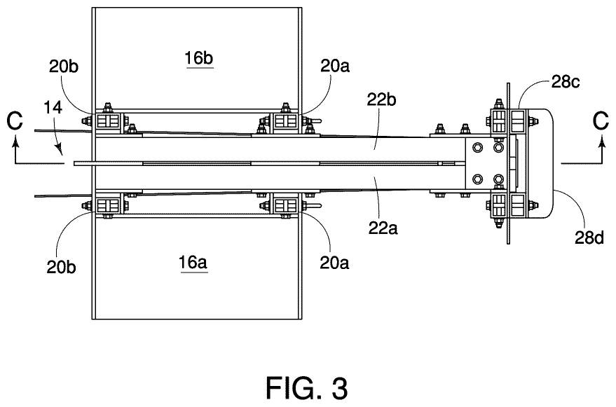

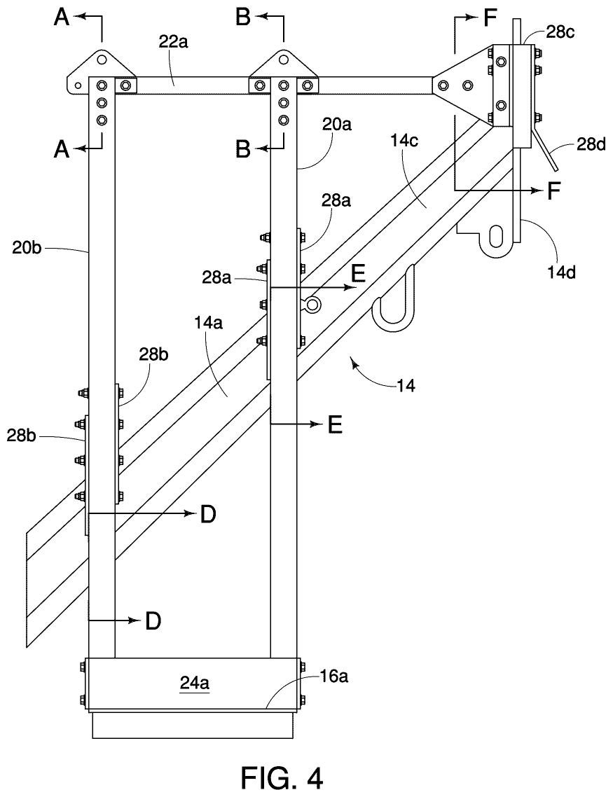

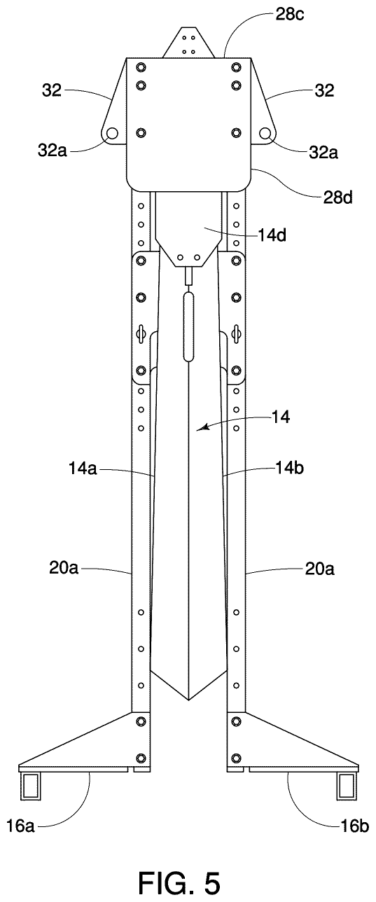

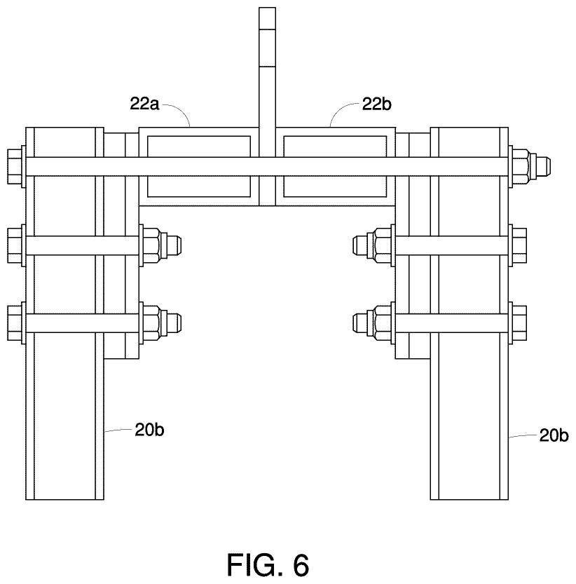

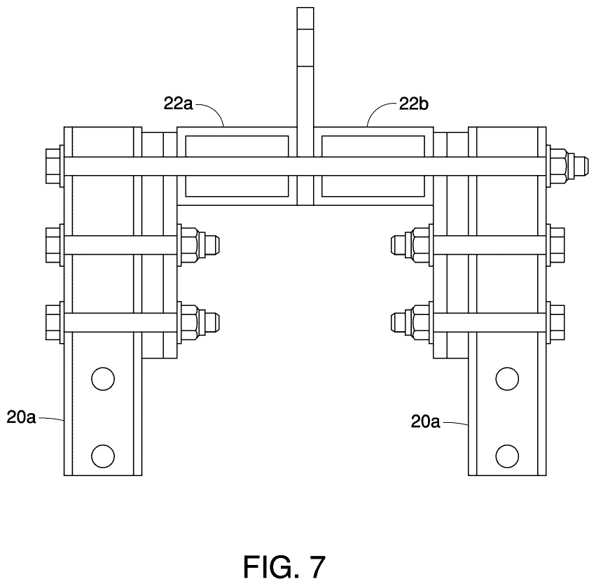

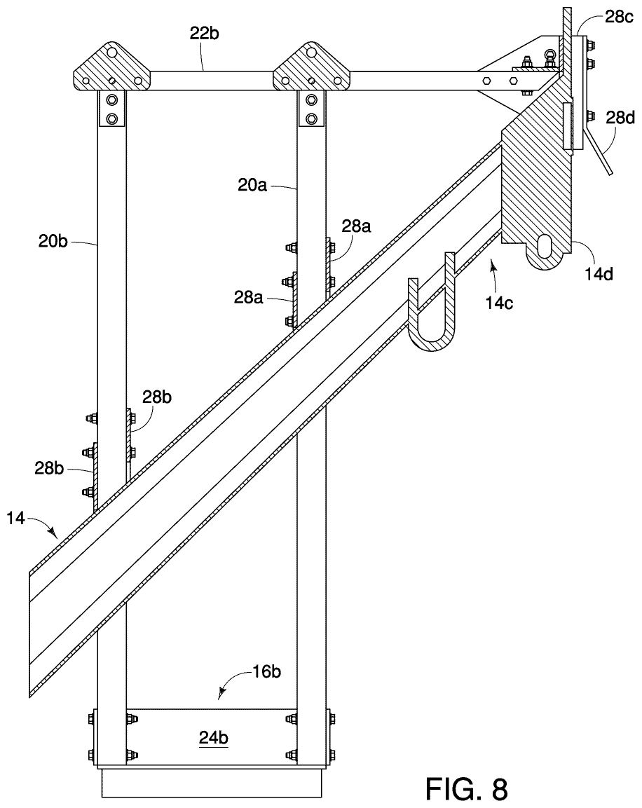

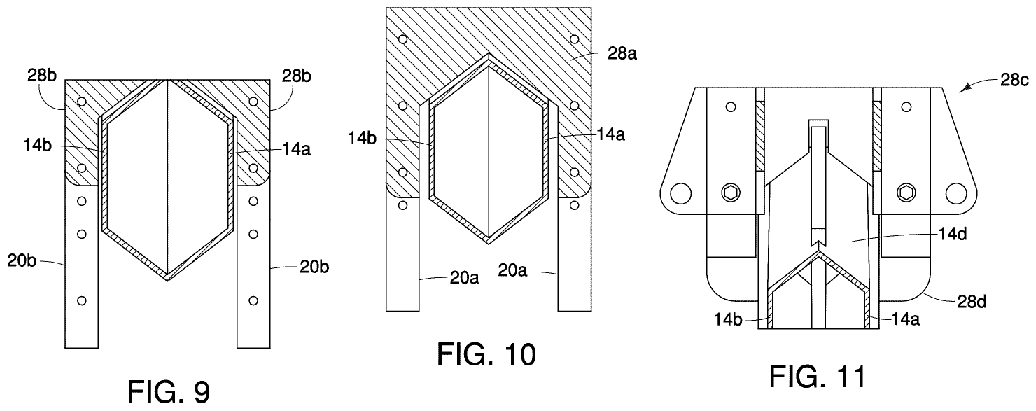

As seen in the embodiment of FIG. 1, a static arm platform 10, better seen by way of example in FIG. 2, is, in the illustrated example, mounted onto the upper end of a static arm 14 on monopole 8 by being lowered down onto the static arm 14 on a long line 6a from a hovering helicopter 6. Static arm 14 extends upwardly at an included angle alpha (α_), measured from horizontal cross arm 8a. In FIG. 1, cross arm 8a supports a three sub-conductor phase bundle 8c on a pair of insulators 8b. A lineman 4, also lowered on the long line 6a, stands on platform 10 once it is mounted onto the static arm 14 so as to accomplish work at the end of the static arm 14. By way of further example, the lineman 4 may be restringing a static wire 2 using a traveller 2a suspended from the end of the static arm 14.

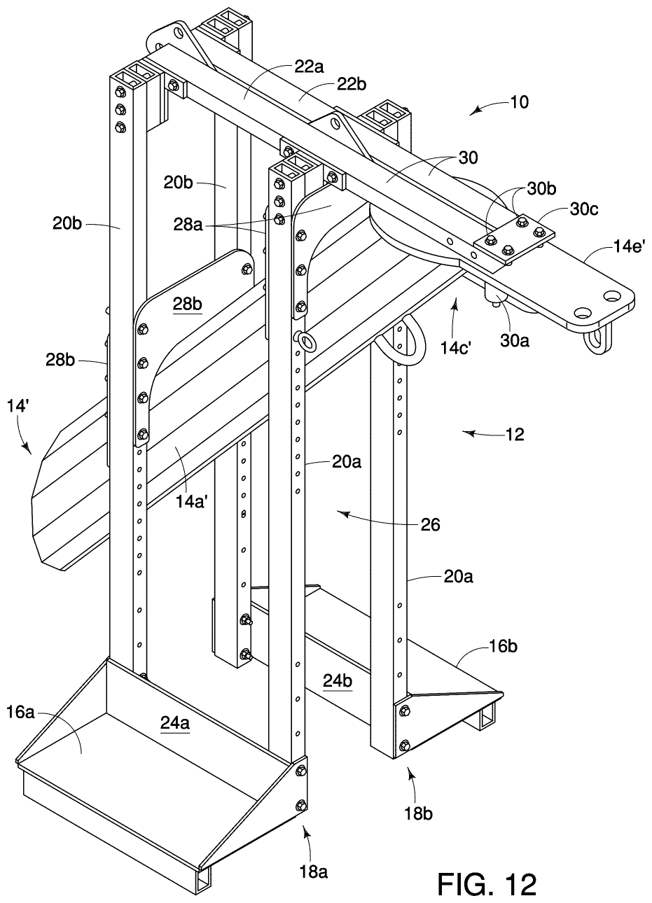

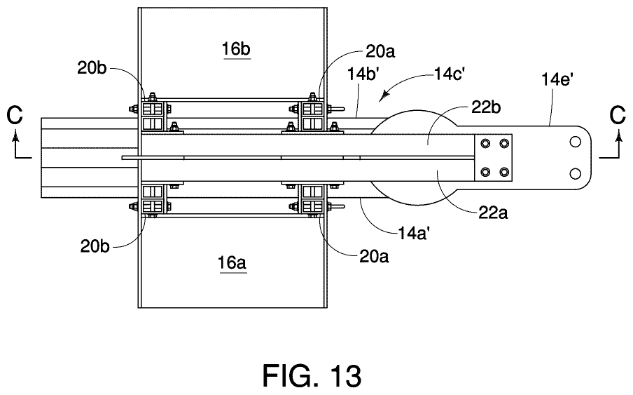

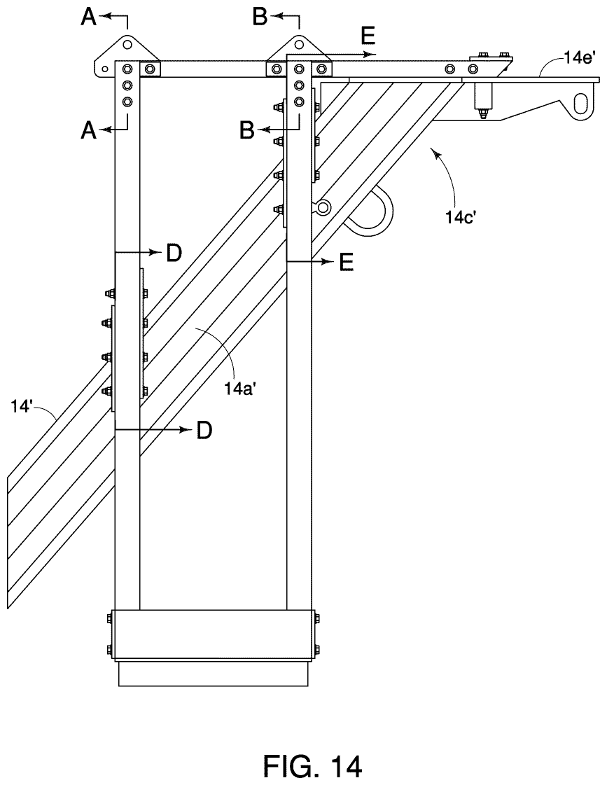

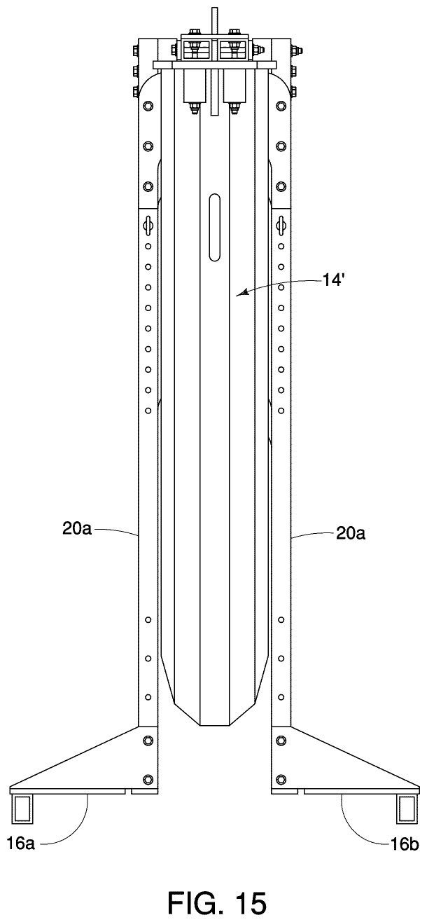

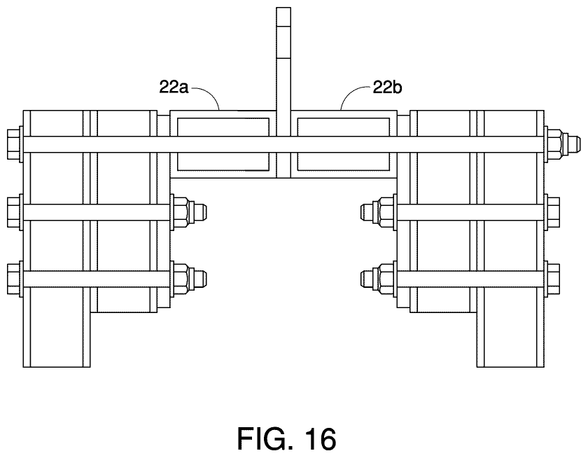

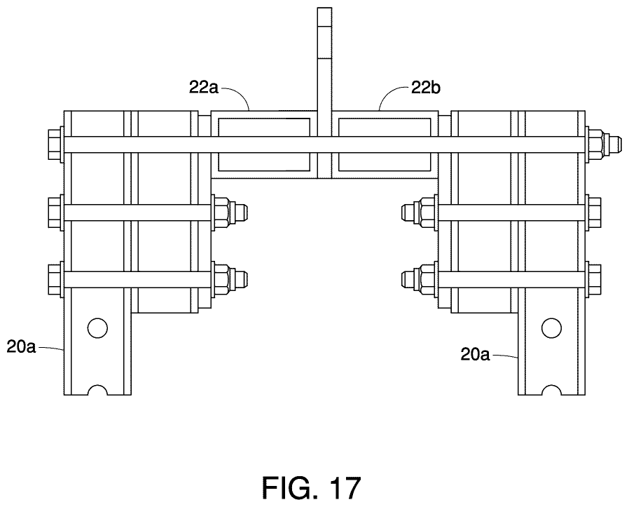

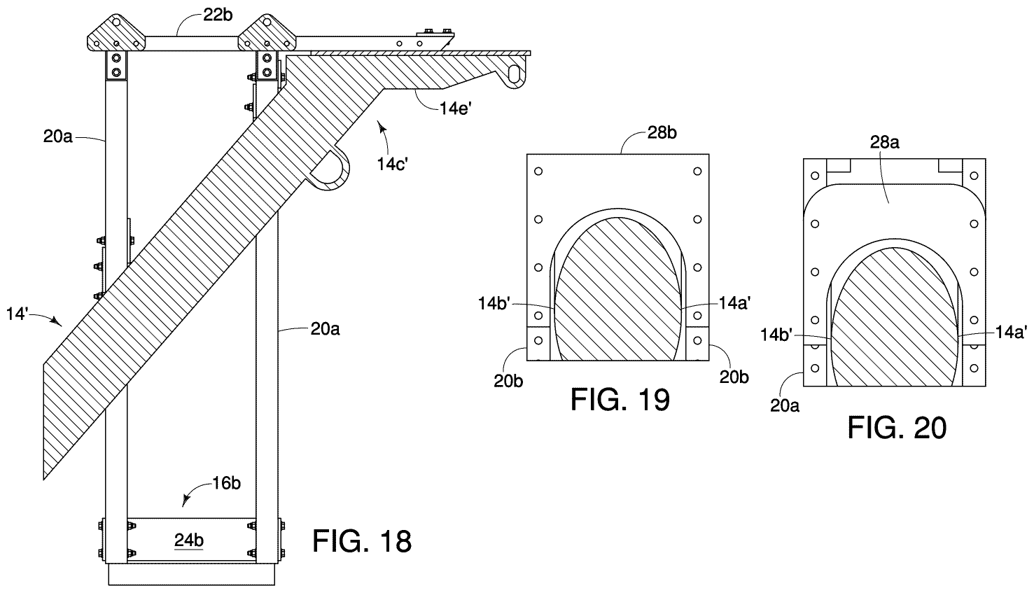

As seen in FIG. 2, static arm platform 10 may include what is generally referred to herein as a saddle 12. In FIGS. 1 and 2, saddle 12 mounts down over a static arm 14 so as to rest thereon. In FIG. 2, static arm 14 is of the type of static arm having a vertical end plate. In FIG. 12, saddle 12 mounts down over a static arm 14′ of the type of static arm having a horizontal end plate. Saddle 12 mounts down onto the static arms 14 or 14′ so as to support oppositely disposed foot decks 16a and 16b extending outwardly and generally horizontally from rigid flanks 18a and 18b which envelope the sides 14a, 14b and 14a′, 14b′ respectively of static arms 14 and 14′. In the illustrated embodiments, not intended to be limiting, flanks 18a and 18b may each be a rectangular frame having front and rear legs 20a and 20b respectively, rigidly connected by top rails 22a and 22b at the upper ends of the flanks 18a and 18b, respectively, and rigidly connected by backing plates 24a and 24b, which lend to the rigidity to foot decks 16a and 16b, at the lower ends of flanks 18a and 18b. The foot decks are sufficiently large in horizontal area so that a lineman may comfortably stand with both feet on the foot deck. The flanks of the saddle may be of a height, for example 74 inches, so that the lineman standing on a foot deck has relatively comfortable access to a static wire suspended from the end of the static arm and adjacent the static arm platform.

Rigid flanks 18a and 18b may be, as illustrated, again without intending to be limiting, rectangular frames each formed by the front and rear legs, the top rails, and the backing plates. The flanks 18a and 18b may be parallel to each other, or may be inclined relative to one another, for example slightly inclined, towards one another so that the top rails are closer to one another than are the backing plates to one another, so long as a static arm receiving cavity 26 is formed between the flanks 18a and 18b. The width of the static arm may be approximately 8 to 12 inches for some static arms, and thus the receiving cavity 26 will have a corresponding and sufficient width to allow ease of entry of the static arm into the receiving cavity 26 as the static arm platform 10 is lowered by helicopter down onto the static arm, while still being snugly mounted once lowered onto the static arm. In one embodiment, not shown, the inner surfaces of the flanks 18a and 18b may be lined or coated with a friction reducing liner or coating respectively to ease mounting and demounting of the static arm platform onto the static arm. For example, the liner may be strips of UHMW polyethylene sheet. In another embodiment, not shown, the lower extremities of the flanks may be slightly flared outwardly, thereby flaring the lower opening into the cavity 26, to assist in capturing the static arm into the cavity 26 while mounting the static arm platform onto the static arm.

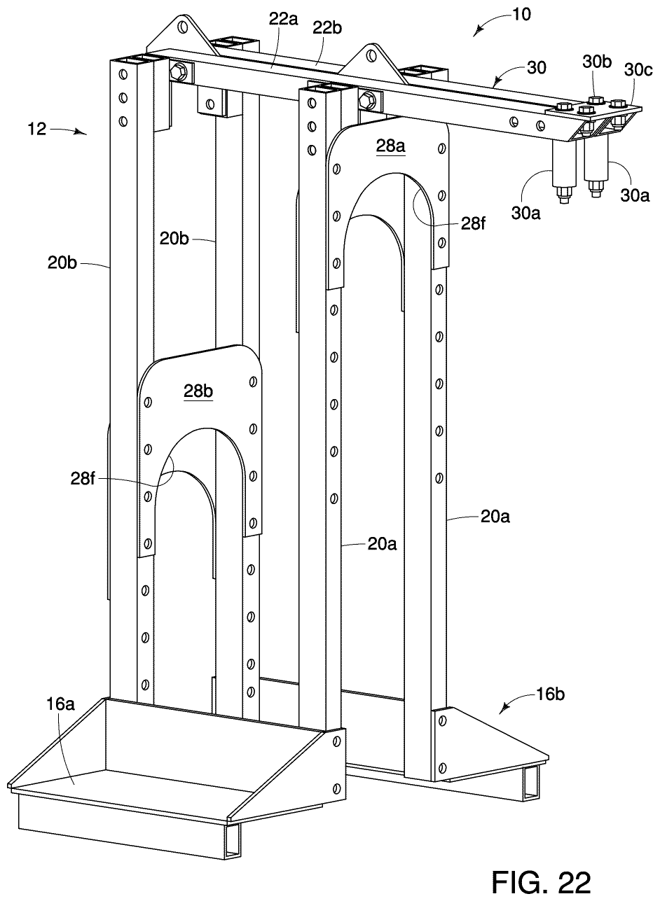

The flanks of the static arm platform are held rigidly spaced apart by gussets. In one embodiment, flanks 18a and 18b are rigidly held spaced apart by gusset plates, and in the illustrated example by a front or forward gusset plate 28a and a parallel rear gusset plate 28b. The forward gusset plate and the rear gusset plate may, as illustrated each be a pair of plates bolted to the front and rear surfaces of their corresponding front legs and rear legs respectively. Each of the forward and rear legs has bolt holes along at least a part of their length. As illustrated, the static arms 14, 14′ are inclined upwardly by an angle alpha. Static arms 14, 14′ terminate at their upper or distal ends 14c, 14c′. Because the top rails are to be maintained horizontal, thereby maintaining the foot decks also horizontal, the rear gusset plate 28b is lower along the corresponding legs 20b than the forward gusset plate 28a is along the corresponding legs 20a. Consequently, the linear vertical array of bolt holes on the rear legs may be lower, or extend longer along the rear legs than the bolt holes on the front legs. The arrays of bolt holes are provided so that the elevation of the gusset plates may be adjusted to account for the angular inclination alpha of the static arm so as to maintain the foot decks horizontal. When pre-assembling the static arm platform prior to it being lifted and placed down onto the static arm, the correct gusset plates may be chosen from a set of gusset plates having varying cut-out profiles so that the cut-out profiles 28f, better seen in FIG. 22, in lower ends of the gusset plates match the cross sectional profile of the static arm at the location along the static arm on which it is intended to mount the static arm platform.

Thus, as seen in FIG. 2, gusset plates are chosen that have their cut-out profiles to match a hexagon cross section on the static arm. Further, because in the illustrated examples the static arm tapers from its base end towards its upper, distal end, each position along the static arm will have a unique diameter (reducing as the position moves along the static arm towards its distal end) and each of the sides of the hexagon will have a unique width (also reducing as the position moves along the static arm towards its distal end) at that location along the static arm. Thus, not only may the shape of the cut-out profile in a gusset plate be chosen to match the shape of the cross section of the static arm (e.g., six or twelve sided as illustrated in the examples of FIGS. 2 and 12 respectively), but also to dimensionally match the unique diameter and width dimensions of the panels making up the polygonal cross section of the static arm at the desired locations for the gusset plates along the static arm. The bolt holes in the forward and rear legs provide for mounting the gusset plates at the appropriate location or elevation along the legs so that each of the gusset plates rests conformally on, where desired along, the static arm, and also allow for the height or elevation of the foot decks to be adjusted relative to the legs, and thus relative to the static arm.

In the embodiment of FIG. 2, the end 14c of the static arm 14 has a vertical end plate 14d. Vertical end plate 14d slides upwardly into a cavity or sheath in end mount 28c as end mount 28c is lowered as saddle 12 is mounted onto static arm 14. It is thus useful to pre-assemble the end mount 28c onto the end of the arm extensions 30 of top rails 22a, 22b to take advantage of the presence of the vertical end plate 14d to provide the third anchoring point of the static arm platform onto the static arm. The end mount 28c slides down onto vertical end plate 14d so as to secure the vertical end plate within the end mount. A striker plate 28d assists in capturing the top of the vertical end plate 14d when aligning the end mount as it is lowered onto the vertical end plate.

In the embodiment of FIG. 12, static arm 14′ has a different upper end configuration as compared to the upper end configuration of the static arm in FIG. 2. In FIG. 12, static arm 14′ has a horizontal end plate 14e′ on the end of the arm. Consequently, the arm extensions 30 of the top rails are merely fastened directly onto the flat, horizontal end plate 14e′ at the end of the static arm 14′, for example, in the manner illustrated, using fasteners such as pins 30a, better seen in FIG. 22, extending through corresponding holes in plate 14e′. Pins 30a are supported by bolts 30b through fastener plate 30c.

In the embodiment of FIG. 2, rigging holes 32a are provided in ears 32 extending out laterally from both sides of end mount 28. The rigging holes provide a lifting attachment for a chain hoist or the like for lifting a static wire 2 (seen in FIG. 1 and shown in FIG. 2 as a dotted line) strung under the upper end of the static arm.

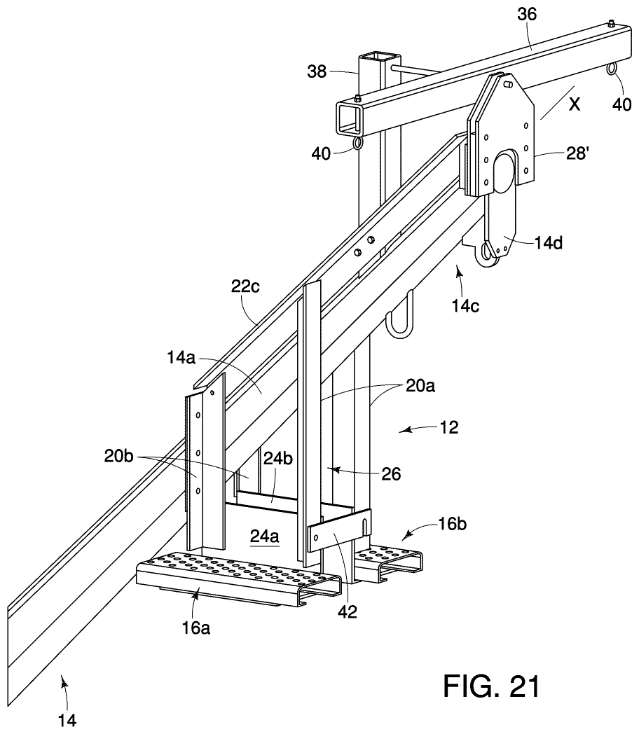

In the embodiment of FIG. 21, instead of gusset plates, and the profiled cut-outs 28f therein, providing the snug fit of saddle 12 around the static arm 14 so as to resist rotation of saddle 12 about the longitudinal axis X of static arm 14, the vertical legs 20a,20b slide down closely along and over the sides 14a, 14b of static arm 14 providing a snug fit to resist the rotation of the saddle 12 about the static arm. The vertical legs are mounted at their upper ends to a backbone rail, formed by a pair of parallel rails 22c, which, when saddle 12 has been installed onto the static arm, extends flush up and along the top or upper surface of the static arm. Vertical end plate 14d is mounted to the upper end of rail 22c. An end mount 28′ slides down so as to couple with vertical end plate 14d. A spreader bar 36, supported by a post 38 mounted between the pair of parallel rails 22c, supports the spreader bar 36 from the rear. The front of the spreader bar 36 is pinned to the upper end of end mount 28′. Eyebolts 40 on either end of spreader bar 36 provide rigging lifting attachments for chain hoists or the like for a lineman lifting the static wire 2. A swing arm 42 having a latch at one end provides additional rigidity to the structure and secures the static arm platform to the static arm. Swing arm 42 swings up out of the way when the static arm platform is installed or removed.

The previous description of the disclosed embodiments is provided to enable any person skilled in the art to make or use the present disclosure. Various modifications to those embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

1. A static arm platform for mounting onto a static arm comprising a rigid saddle adapted for releasable mounting down onto the static arm, at a desired location along the static arm dictated by a pre-chosen static arm cross section profile formed as lower cut-outs in a pair of gusset plates mounted at each end of the saddle, wherein the gusset plates are mounted so as to cross between a pair of rigid flanks extending down the sides of the saddle and the lower cut-outs snuggly fit onto and over the static arm at the desired locations on the static arm with sufficiently close tolerance fit so as to resist a rotation of the saddle relative to the static arm when a lineman is standing on one of a pair of foot decks mounted at the lower ends of the rigid flanks, and further wherein the rigid flanks define a static arm receiving cavity to envelope the static arm when the static arm platform is mounted on the static arm.

2. The static arm platform of claim 1, wherein the rigid flanks are parallel, and laterally spaced apart a sufficient lateral distance so that the static arm receiving cavity formed between the rigid flanks fits over the static arm as the saddle is lowered into place.

3. The static arm platform of claim 2, which, when being lowered, is adapted to be guided by the lineman also simultaneously lowered as a combination underslung load by a helicopter so that, as the lower ends of the rigid flanks slide down past the sides of the static arm, the lower cut-outs in the gusset plates, engage the static arm, and snugly seat down onto the static arm where the corresponding cross sectional profiles of the static arm dimensionally match the dimensions and shape of the cut-outs.

4. The static arm platform of claim 2, wherein upper ends of the rigid flanks support an end mount on a coupling arm extending from the upper ends of the rigid flanks so as to anchor the saddle onto the distal end of the static arm.

5. The static arm platform of claim 4, wherein the rigid flanks are rectangular planar frames having vertical legs, and horizontal upper and lower members outlining the circumference of each of the rectangular frames.

6. The static arm platform of claim 5, wherein the lower members of each frame are formed as backing plates bracing the vertical legs and supporting the foot decks.

7. The static arm platform of claim 4, wherein rigging holes are provided on both sides of the end mount so as to provide a lifting attachment for a chain hoist or the like for lifting a static wire running under the upper end of the static arm.

8. The static arm platform of claim 1, wherein the gusset plates are removable from the saddle and replaceable with replacement gusset plates chosen from a set of gusset plates having different cut-out profiles to match differently shaped static arms.

9. The static arm platform of claim 8, wherein cross sections of the differently shaped static arms are polygons having different numbers of panels forming the polygonal cross section of each static arm.

10. The static arm platform of claim 1, wherein the elevation of the foot decks on the rigid flanks are selectively adjustable.

11. The static arm platform of claim 10, wherein the foot decks are rigidly cantilevered outwardly, in opposed directions, from the rigid flanks of the saddle.

12. The static arm platform of claim 1, wherein the elevations of the gusset plates relative to the rigid flanks are selectively adjustable.
